(19) United States
(12) Patent Application Publication
(10) Pub. No.: US 2004/0096212 A1
(43) Pub. Date: May 20, 2004

(54) Optical channel monitoring device

(75) Inventors: Robert R. McLeod, Morgan Hill, CA (US); Wei-Hung Loh, Mountain View, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA (US)

(21) Appl. No.: 10/295,365

(22) Filed: Nov. 15, 2002

(51) Int. Cl. H04B 10/08

(52) U.S. Cl. 398/25; 398/30

(57) ABSTRACT

An apparatus for measuring optical performance of a plurality of channels within an input optical multi-channel signal employs at least one optical interleaver to deinterleave the input signal into a plurality of channel subsets, each channel subset having a greater channel spacing than the input multi-channel signal, and a switch for sequentially submitting the deinterleaved subsets to an optical performance monitor (OPM). The design allows for relaxed specification of the OPM, e.g. its resolution and number of pixels.

### RELATED APPLICATIONS

None

### TECHNICAL FIELD

This invention relates generally to signal monitoring devices for optical telecommunication networks, particularly to an optical channel monitoring device capable of detecting and measuring at least the power, or intensity, of each of a plurality of wavelength channels.

### BACKGROUND ART

One of the functions of a known optical performance monitor (OPM) is to identify and measure the power in each channel of a wavelength division multiplexed (WDM) signal. Some OPMs, as for example OPM512, a 50 GHz, 512 pixel monitor available from Ocean Optics, USA, are also capable of measuring the optical signal-to-noise ratio (OSNR) of multiple wavelength channels. OPMs without such capability are sometimes referred to as optical channel monitors (OCM).

U.S. Pat. Nos. 6,396,603 (Samsung Electronics) and 6,441,933 (LG Electronics) describe two exemplary devices for monitoring the performance of optical channels in telecommunication networks.

All OCMs or OPMs have a finite spectral resolution which limits the minimum separation between channels as well as the number of channels that can be measured at the same time. With current OCM (OPM) technologies, the typical minimum channel spacing is 50 GHz. As channel spacings decrease due to an imminent demand for bandwidth, it will be necessary to extend the minimum channel spacing to 25, 12.5 GHz or even less.

Beside the finite spectral resolution, another inherent barrier of an OPM is the maximum number of channels that can be measured at one time. This number depends on the number of pixels required for measuring one channel. For example, OCMs based on detector arrays require minimum of 3-4 pixels per channel and thus are limited to measuring less than N/3 channels where N is the number of pixels in the detector array (typically 256 or 512 like in the exemplary OPM512 device, above).

### SUMMARY OF THE INVENTION

It is desirable to overcome or at least reduce the above-described disadvantages of the known monitoring devices. This has been accomplished according to the invention by multiplying (doubling, tripling, quadrupling etc.) the useful channel density of a known optical performance monitor by coupling at least one interleaver in the optical path between the monitored multi-channel optical signal and the monitor.

In accordance with one aspect of the invention, there is provided an apparatus for measuring optical performance of a plurality of channels within an optical multi-channel signal, the apparatus comprising:

an input port for receiving said multi-channel signal,

an optical interleaver coupled to the input port for dividing said signal into a plurality of channel sets, each set having a greater channel spacing than the multi-channel signal, and

at least one optical performance monitor coupled to the optical interleaver for monitoring each of said channel sets.

As inherent in an optical interleaver, the wavelengths in one channel set are interleaved with wavelengths in another channel set of the plurality of sets such that the respective wavelength ranges are overlapping.

In an embodiment of the invention, the apparatus may comprise an optical switch for sequentially connecting the channel sets produced by the interleaver with the channel monitor.

In accordance with another aspect of the invention, there is provided a method for measuring the optical performance of a plurality of channels within an optical multi-channel signal, the method comprising:

dividing said multi-channel signal into a plurality of subsets of channels, each channel subset having a greater channel spacing than the multi-channel signal,

monitoring each subset and detecting at least the intensity of each channel of each subset, and

providing an output indicative of the intensity of each channel of each subset.

One advantage of the present invention is that due to the provision of an interleaver, the optical monitor can have a relatively low resolution.

### BRIEF DESCRIPTION OF THE DRAWINGS

The invention will be described in more detail by way of the following disclosure in conjunction with the drawings in which like reference numerals denote like elements, and in which

FIG. 1 is a schematic representation of a prior art optical performance monitor,

FIG. 2 is a schematic representation of one embodiment of the invention, employing one interleaver and a switch,

FIG. 3 is a schematic representation of another embodiment of the invention, employing two interleavers and two switches,

FIG. 4 shows a theoretical spectrum of 10 Gb channels on a 25 GHz grid at the input port,

FIGS. 5a and 5b illustrate two spectra produced by the interleaver,

FIG. 6 illustrates effective isolation of the interleaver as a function of the drift of the adjacent signal source and locking accuracy for various contrasts of the interleaver,

FIG. 7 is a graph illustrating the crosstalk effect of the laser drift in optical frequency, and

FIG. 8 is a graph illustrating the attenuation effect of the laser drift in optical frequency.

### DETAILED DESCRIPTION OF THE EMBODIMENTS OF THE INVENTION

In the present specification, the terms “interleaver” and “deinterleaver” are used interchangeably. The same applies to terms “optical channel monitor” and “optical performance monitor” unless a difference therebetween is expressly stated.

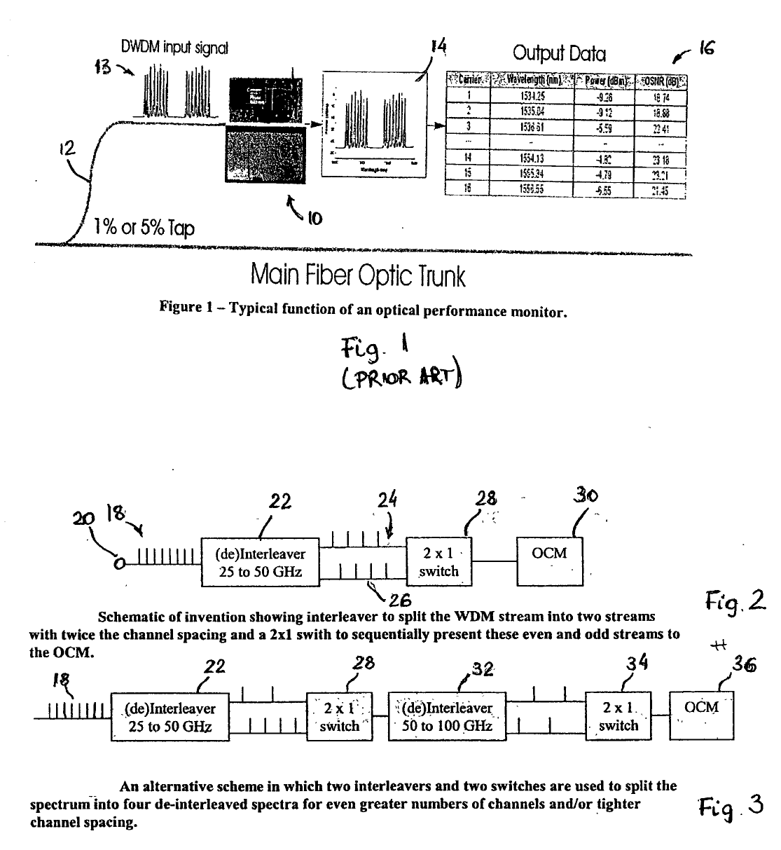

FIG. 1 shows a conventional optical performance monitor (OPM) 10 coupled to receive a tapped DWDM optical signal 12 having a plurality of wavelength channels 13. The spectrum display 14 produced by the OPM is seen to show the intensity of each channel as a function of the wavelength. Output data 16 are generated to display numerically the power (amplitude) and OSNR for each wavelength.

For the purpose of illustrating the invention, a simpler OCM is used as seen in FIG. 2. A WDM input stream 18 received at an input port 20 is coupled to a 25-to-50 GHz interleaver/deinterleaver 22. The interleaver/deinterleaver (operating here as a deinterleaver) produces two sub-beams 24, 26, each sub-beam carrying a subset of optical channels with different wavelengths, e.g. odd wavelengths λ₁, λ_{3, λ}₅ . . . in one stream 24 and even frequencies λ₂, λ₄, λ₆ . . . in the other stream.

Both de-interleaved streams, with the respective wavelength channels in each stream spaced by 50 GHz, twice the amount of spacing of channels of the original signal 18, are coupled to a conventional 2×1 switch 28. The switch can be operated manually or automatically to couple one or the other de-interleaved stream 24, 26, to the optical channel monitor 30. The monitor 30 produces typical channel performance data (intensity vs. wavelength) of the streams 24, 26 sequentially coupled thereto.

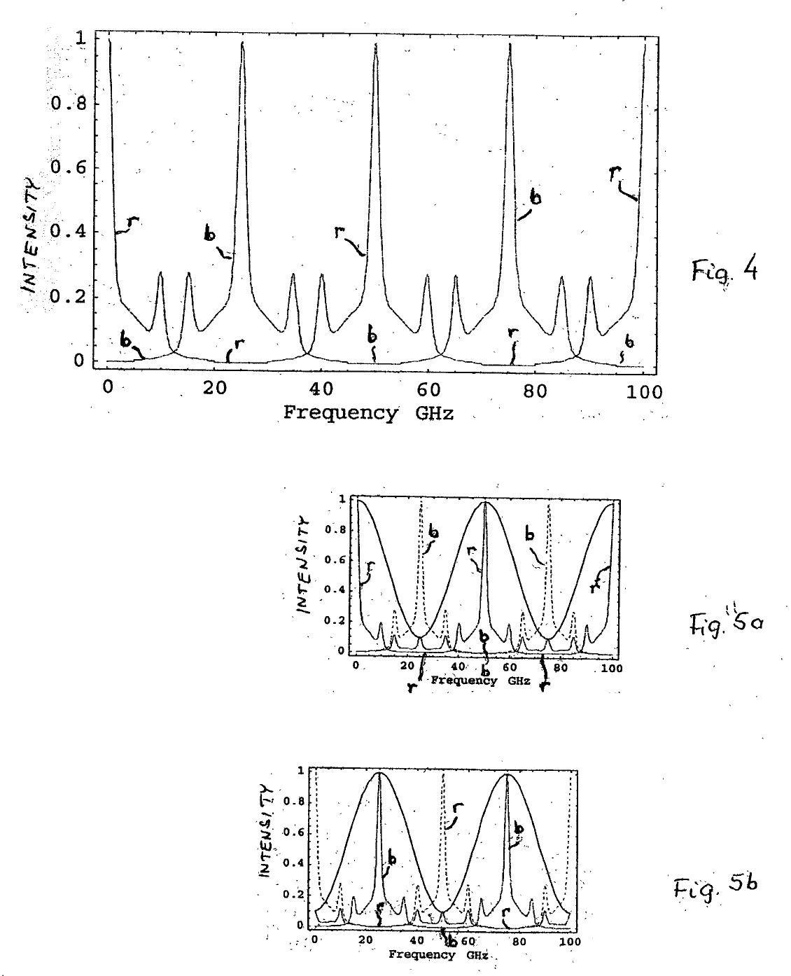

In an embodiment shown in FIG. 3, the apparatus has two interleavers/deinterleavers 22, 32, the second interleaver for converting a 50 GHz multi-channel signal into two 100 GHz signal beams. The second interleaver 32 is coupled between a first 2×1 switch 28 and a second 2×1 switch 34. The second switch 34 is coupled with OCM 36.

It will be easily understood that the OCM 36 in the embodiment of FIG. 3 may be of relatively low specification (resolution and channel capacity, or number of pixels) as only a quarter of the original channel number in the input signal 18 reaches the OCM 36 at one time.

It will also be realized that the arrangement of FIG. 3 can be replaced by an analogous arrangement where a single 1×4 interleaver and a 4×1 switch can perform the same function as the two interleavers and switches of the embodiment of FIG. 3, and the resulting four sub-beams may be sequentially presented to the monitor. It is also conceivable to provide a plurality of interleavers, whether arranged in series or in parallel, and a corresponding switch or a plurality of switches.

Interleavers (de-interleavers) and switches can have inherent performance limitations, as discussed in more detail below. For example, interleavers have a finite contrast, and cross-talk can take place between the odd and even channels. This limitation, affecting the quality of the divided subsets, can be overcome or at least partially compensated by digital signal processing within the OCM. The processing allows for the employment of interleaver (s) and/or switch or switches of significantly lower performance and cost than those used for conventional DWDM mux/demux applications.

To illustrate this point, FIG. 4 shows a theoretical spectrum of 10 Gb NRZ (non-return to zero) channels on a 25 GHz grid. For clarity, even channels are marked with letter “r” and odd channels are marked with “b”. It is seen that adjacent channels nearly overlap which would require a very high resolution OCM or OPM to accurately separate the channels and accurately measure their power.

FIGS. 5a (even channels) and 5b (odd channels) show how the signal of FIG. 4 is split into primarily even and odd spectra by the interleaver. In FIG. 5a, the passed signals are marked “r”, and the attenuated signals are marked “b”. In FIG. 5b, the passed signals are marked “b” and the attenuated signals are marked “r”. The interleaver chosen for this example has a sinusoidal passband, not square one, and only 10 dB of contrast (conventional DWDM interleavers have a relatively square pass and stop bands and significantly more than 10 dB contrast). As a result, the adjacent channels are not fully attenuated. Dotted curves show the original spectrum of the attenuated channels for comparison.

An important factor in the apparatus of the invention is the locking of the transmission lasers to their nominal frequency on the grid. As the lasers drift, the channels that should be rejected by the interleaver shift from the maximum attenuation frequency and contribute more crosstalk. The effective isolation of the interleaver is shown in FIG. 6 as a function of the locking accuracy and for contrasts of 10, 15, and 20 dB. The absolute value of the isolation (JS, isolation is a negative number) decreases as the locking accuracy degrades and this effect is faster for interleavers having lower contrasts. A more expensive square band-pass interleaver would mitigate this problem.

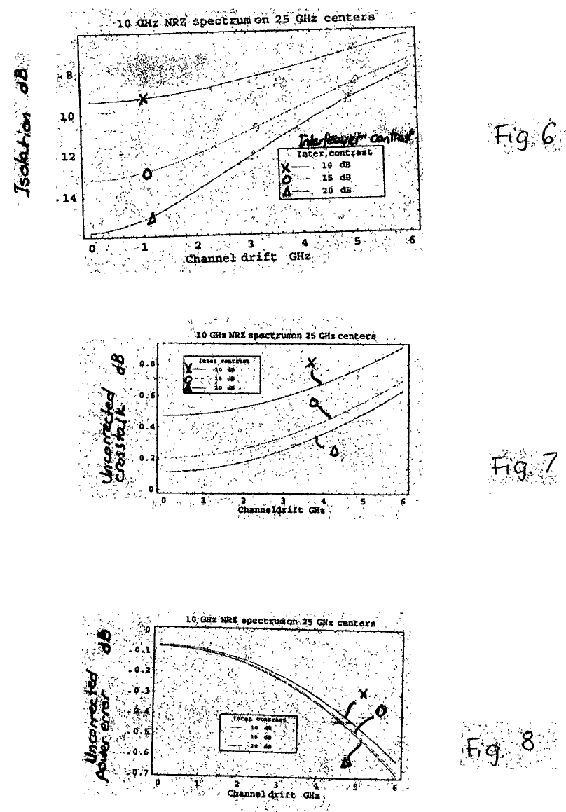

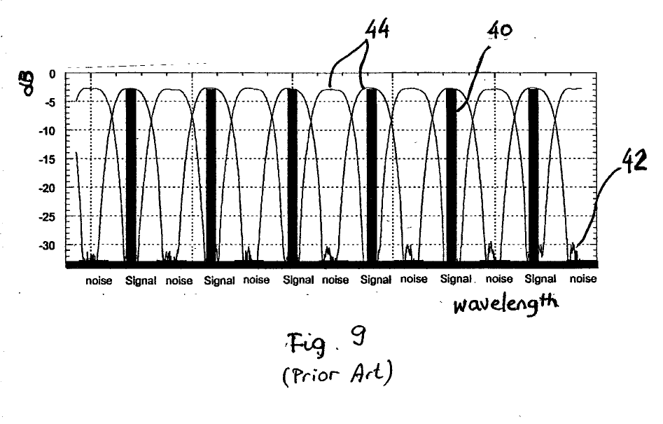

However, as shown in FIGS. 7 and 8, the final contributions to measured power error of the OCM from interleaver crosstalk and laser optical frequency drift are still rather small. One effect (shown in FIG. 7) is the crosstalk from adjacent channels increasing the power in the measured channel. The other effect (FIG. 8) is attenuation of the power in the intended channel as it drifts off of the interleaver peak. IN both figures, the interleaver contrast curves are denoted by “x” for 10 dB contrast, “O” for 15 dB contrast and “Δ” for 20 dB. Both effects (crosstalk, FIG. 7 and attenuation of the channels being measured, FIG. 8) are in the range of 0.5 dB. While this is a significant number for the power error, it is small enough to be corrected in a known manner by the software of the OCM, by measuring the wavelength drift of the lasers and applying a calibration.

The same arguments apply to switches, i.e. poor isolation can be corrected in the OCM by the associated software.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. An apparatus for measuring optical performance of a plurality of channels within an optical multi-channel signal, the apparatus comprising:
an input port for receiving said multi-channel signal,
an optical interleaver coupled to the input port for dividing said signal into a plurality N of channel subsets, each channel subset having a greater channel spacing than the multi-channel signal, and
at least one optical performance monitor coupled to the optical interleaver for monitoring each of said channel subsets.

2. The apparatus of claim 1 further comprising at least one switch coupled to receive said channel subsets and direct the subsets sequentially to the optical performance monitor.

3. The apparatus of claim 2 comprising an optical 1×2 interleaver and a 2×1 switch.

4. The apparatus of claim 2 comprising a 1×4 interleaver and a 4×1 switch.

5. The apparatus of claim 2 comprising a plurality of interleavers and at least one optical switch.

6. A method for measuring the optical performance of a plurality of channels within an optical multi-channel signal, the method comprising:
dividing said multi-channel signal into a plurality of subsets of channels, each channel subset having a greater channel spacing than the multi-channel signal,
monitoring each subset and detecting at least the intensity of each channel of each subset, and
providing an output indicative of the intensity of each channel of each subset.

7. The method of claim 6 wherein each subset is monitored sequentially.

8. The method of claim 6 wherein channels in one subset have wavelengths interleaved with wavelengths in another subset.

9. The method of claim 6 further comprising the step of adjusting the detected intensity in response (to changes in the subset caused by dividing said signal into the subsets) to the optical characteristics of means for dividing said signal into the subsets.
